(19) United States
(12) Patent Application Publication
(10) Pub. No.: US 2025/0136078 A1
(43) Pub. Date: May 1, 2025

(54) BRAKING DEVICE FOR A MOTOR VEHICLE

(71) Applicant: DAIMLER TRUCK AG, Leinfelden-Echterdingen (DE)

(72) Inventor: Frank STEFFENS, Ostfildern (DE)

(21) Appl. No.: 18/683,059

(22) PCT Filed: Aug. 2, 2022
(86) PCT No.: PCT/EP2022/071612

§ 371 Date: Feb. 12, 2024

(30) Foreign Application Priority Data
Aug. 12, 2021 (DE) 10 2021 004 154.2

(51) Int. Cl. B60T 10/02; F16D 57/04

(52) U.S. Cl. CPC B60T 10/02; F16D 57/04

(57) ABSTRACT

The invention relates to a braking device (10) for a motor vehicle with a fluid path (12) through which a fluid can flow and which has at least two line sections (14, 16), in which at least one pump element (18) and at least one valve device (34) which has a valve inlet (26) and a valve outlet (28) and which can be moved between at least two valve positions (30, 32) is arranged, wherein the valve device is fluidically connected to the pump element (18) via the valve inlet (26) by means of a first of the line sections (14), with a retarder (38), which has a stator (40), a rotor (42) and a retarder inlet (44), via which the retarder (38) is fluidically connected to the valve device (34) by means of the second of the line sections (16) via the valve outlet (28), wherein in a first of the valve positions (30) the valve inlet (26) is fluidically connected to the valve outlet (28) and in the second valve position (32) the valve inlet (26) is not fluidically connected to the valve outlet (28).

The invention relates to a braking device in accordance with the generic term of patent claim 1.

DE 101 41 794 A1 discloses a hydrodynamic retarder for a motor vehicle with a circuit for controlling the retarder, which contains a hydraulic pump, a heat exchanger, a valve and a control and regulation unit, whereby the delivery volume of the pump can be adjusted in such a way that the volume flow can be set depending on the vehicle speed or drive shaft speed or retarder speed.

The object of the present invention is to create a braking device for a motor vehicle in order to be able to keep the installation space and costs of the braking device particularly low.

According to the invention, this object is achieved by a braking device for a motor vehicle with the features of claim 1. Advantageous embodiments with useful further embodiments of the invention are described in the remaining claims.

The invention relates to a braking device for a motor vehicle, which is preferably designed as a commercial vehicle, in particular as a heavy goods vehicle. The motor vehicle can be designed as a motor vehicle, in particular as a passenger car, commercial vehicle or truck, or as a passenger bus. The motor vehicle can be a battery electric vehicle, a fuel cell vehicle or a hybrid vehicle, for example. For example, the motor vehicle can have an internal combustion engine by means of which the motor vehicle can be propelled at least to some extent. Preferably, the braking device is intended to decelerate the motor vehicle. This allows the speed at which the vehicle is traveling on a roadway to be reduced by means of the braking device. The vehicle can thereby be decelerated to a standstill, for example, by means of the braking device.

The braking device comprises a fluid path through which a fluid can flow and at least two line sections through which the fluid can flow, which can be referred to in particular as a hydraulic system. At least one pump element, referred to in particular as an oil pump, is arranged in the fluid path for conveying the fluid through the fluid path. The pump element is preferably designed as an electric pump.

At least one valve device through which the fluid can flow, having at least one valve inlet and at least one valve outlet that is spaced apart from the valve inlet and can be moved between at least two valve positions, is arranged in the fluid path. The valve device is fluidically connected or can be connected to the pump element by means of a first of the line sections. In other words, the first line section is intended to fluidically connect a pump outlet of the pump element through which the fluid can flow to the valve inlet of the valve device. The fluid can flow through the valve inlet and the valve outlet.

The braking device comprises at least one retarder, which has a stator, a rotor that is formed separately from the stator and can rotate about an axis of rotation relative to a housing element of the retarder, and a retarder inlet. The fluid can be supplied to the retarder via the retarder inlet. The retarder is fluidically connected or can be connected via the retarder inlet to the valve device via the valve outlet by means of the second of the line sections. In other words, the second line section is intended to fluidically connect the valve outlet of the valve device to the retarder inlet. The fact that the braking device has the retarder means that the braking device can be referred to in particular as a retarder system.

In a first of the valve positions of the valve device, the valve inlet is fluidically connected to the valve outlet, whereby the fluid flowing through the first line section can be supplied via the valve inlet through the valve device, via the valve outlet and the second line element to the retarder inlet. In the second valve position of the valve device, the valve inlet is not fluidically connected to the valve outlet, which means that the fluid flowing through the first line section cannot flow through the valve device and thus cannot be supplied to the retarder inlet via the second line element. In the first valve position, the fluid flows through the first line section in a first direction of flow of the first line section.

For example, the valve device has a through-channel through which the fluid can flow and which can be fluidically connected to the valve inlet and the valve outlet. For example, in the first position, the through-channel is released, whereby the fluid flowing through the first line section can be supplied via the valve inlet, via the through-channel, via the valve outlet and via the second line element to the retarder inlet. For example, the through-channel is blocked in the second position, which means that the valve inlet and the valve outlet are not connected to each other. As a result, the fluid flowing through the first line section in the second valve position cannot be supplied to the retarder inlet via the valve inlet, the through-channel, the valve outlet and via the second line element. In particular, the valve device can be referred to as a valve block. The valve device is preferably designed as a directional control valve.

In order to be able to keep the installation space and costs of the braking device particularly low, the braking device has at least one coupling element, via which the rotor of the retarder can be coupled to a drive shaft of the motor vehicle and decoupled from the drive shaft, and a coupling device. The drive shaft can be rotated about a shaft rotation axis of the drive shaft relative to the housing element. The drive shaft can, for example, be driven by an electric motor of the motor vehicle and/or by the internal combustion engine, whereby the wheels of the motor vehicle can be driven via the drive shaft. Coupling the rotor to the drive shaft means that the rotor can be coupled to the drive shaft in a torque-transmitting or torsionally rigid manner, whereby, for example, a torque provided by the drive shaft can be transmitted to the rotor.

By means of the coupling device, the rotor and the drive shaft can be coupled via the coupling element by moving the valve device into the first valve position and can be decoupled by moving the valve device into the second position. In other words, the coupling element and the valve device are coupled via the coupling device in such a way that the rotor and the drive shaft are coupled to one another via the coupling element in the first valve position and are decoupled from one another in the second valve position. To put it in other words again, the valve device has at least one adjustable coupling means, the coupling element being coupled to the coupling means via the coupling device in such a way that the first valve position results in an open coupling element and the second valve position results in a closed coupling element.

The coupling element is arranged between the drive shaft and the rotor with regard to a torque flow running from the drive shaft to the rotor, via which the torque can be transmitted from the drive shaft to the rotor, so that the torque flow runs via the coupling element, in particular when the coupling element is closed. Alternatively, the torque flow can run in the opposite direction from the rotor to the drive shaft via the coupling element. The coupling element has, for example, a first coupling part and a second coupling part. The first coupling part can be connected to the drive shaft in a torsionally rigid manner and the second coupling part can be connected to the rotor in a torsionally rigid manner.

The coupling element can be opened and closed, which means that the coupling element can be switched between an open state and a closed state. In the open state, the drive shaft is decoupled from the rotor. In the closed state, the drive shaft is coupled to the rotor. In the open state, the two coupling parts of the coupling element or the drive shaft and the rotor are decoupled from each other so that, for example, no torque or at most a first torque that is greater than zero in particular can be transmitted between the two coupling parts or between the drive shaft and the rotor. In the closed state, the two coupling parts are connected to each other in a torque-transmitting manner, in particular in a frictionally engaged and/or positive-locking and/or force-fit manner, in such a way that a second torque that is greater than the first torque can be transmitted between the coupling parts or between the drive shaft and the rotor.

A torsionally rigid connection is understood to be a connection between two separately designed components that are connected to each other in such a way that at least relative rotations between the components and preferably relative movements between the components in the axial direction and in the radial direction of the components are prevented or avoided.

In particular, the coupling element can be referred to as a coupler or decoupler. The coupling element can be designed as a positive-locking coupling, in particular as a claw coupling. Furthermore, the coupling element can be designed as a frictionally engaged clutch, in particular as a friction or multi-disc coupling. The drive shaft can, for example, be a transmission shaft of a motor vehicle transmission or can be connected or connectable to the transmission shaft in a torque-transmitting manner.

If the drive shaft and the rotor are coupled to each other via the closed coupling element, the rotor can be driven by the drive shaft and thus rotated about its axis of rotation relative to the housing element. The fluid supplied to the retarder via the retarder inlet can be accelerated by means of the rotor, as a result of which the rotor can be decelerated. For example, the fluid can be routed to the stator as a result of the acceleration in or to the stator and routed from the stator back to the rotor, whereby the rotor can be decelerated. In other words, the rotor pressurizes the fluid, whereby the rotor is decelerated as a result of the pressurization. In particular, braking can be understood to mean that the rotational speed of the rotor is lower than when the rotor does not act on the fluid. The braking of the rotor can be referred to in particular as deceleration. As a result of the rotor decelerating, the drive shaft is decelerated or braked by the retarder, in particular the rotor, because the coupling element is closed. As a result, the motor vehicle can be decelerated by means of the braking device, in particular by means of the retarder. The fact that the rotor can be slowed down by the fluid means that the fluid can be referred to as brake fluid in particular. The retarder can be referred to in particular as an oil retarder.

In a motor vehicle designed as a battery electric or fuel cell vehicle, the braking device is preferably provided as an auxiliary brake. In particular, this can be understood to mean that the motor vehicle has at least one brake, in particular a mechanical brake, which is designed separately from the braking device and by means of which the motor vehicle can be decelerated. For example, when braking or decelerating the vehicle, braking power can be provided partly by the braking device and partly by the brake. Alternatively or in addition, the braking device can be provided as a sustained-action brake in the motor vehicle. The fact that the braking device has the retarder means that the braking device can be referred to in particular as a hydro-brake.

The invention is based in particular on the following findings and considerations: a conventional braking device, in particular an auxiliary brake or sustained-action brake, can be designed in particular as an electric motor brake, which can be referred to in particular as an electric generator brake. Overload protection must thereby be provided for the electric motor of the motor vehicle and for an energy storage device, in particular a battery, of the motor vehicle when the energy storage device is fully charged. In addition, the continuous braking power of the conventional braking device is limited by the maximum regenerative motor power of the electric motor brake, in particular including the inverter power of an inverter. Auxiliary consumers, such as a fan, cannot thereby normally increase the maximum braking power, especially continuous braking power, of the conventional braking device. The conventional braking device can be particularly complex and, for example, require a particularly large installation space and be particularly expensive.

In contrast, the braking device according to the invention has the retarder, which means that the braking device according to the invention does not have the disadvantages of the electric motor brake. The fact that the braking device according to the invention has the coupling device means that an adjusting element designed separately from the coupling device or the valve device for opening or closing the coupling element is no longer required. This means that the fluid can be supplied to the retarder and the coupling actuation or a respective coupling position can be realized by means of exactly one valve device. In addition, a displacement device for displacing the rotor, in particular axially, is no longer required. As a result, the costs and installation space of the braking device or a retarder assembly of the retarder can be kept particularly low. In addition, a particularly high degree of system integration can be achieved. In addition, the braking device or retarder can be designed or manufactured with particularly little effort, as the adjusting element or rotor displacement, for example, is no longer required.

The braking device according to the invention is particularly suitable for use in a battery electric vehicle or in a fuel cell vehicle or in a conventional vehicle which includes, for example, the internal combustion engine. In addition, the braking device preferably comprises separately and easily replaceable components or assemblies, for example the pump element, the valve device or the hydraulic system. As a result, maintenance costs and/or repair costs for the braking system or the vehicle can be kept particularly low. Moreover, there is no need for a seal between the drive shaft and the retarder, especially the rotor. Furthermore, an emptying device is no longer required.

In a further embodiment of the invention, the valve device has a valve spool that can be moved between at least two positions, which in the first valve position is arranged in a first of the positions and in the second valve position is arranged in the second position. In other words, the valve device or the connecting means has the valve spool, referred to in particular as a spool, which can be moved translationally between the at least two positions relative to the housing element, the valve spool being in the first position in the first valve position of the valve device and being in the second position in the second valve position of the valve device. The valve spool can, for example, be designed as a switching piston or control piston. The coupling device is designed as an actuator which is mechanically coupled to the valve spool and can be moved between at least two actuator positions, wherein the actuator can be moved into a first of the actuator positions by moving the valve spool into the first position, whereby the rotor and the drive shaft are coupled via the coupling element, and can be moved into the second actuator position by moving the valve spool into the second position, whereby the rotor and the drive shaft are decoupled form each other. In other words, the actuator is mechanically coupled to the valve spool in such a way that the actuator can be moved or is moved into the first actuator position as a result of the valve spool being moved into the first position and the actuator can be moved or is moved into the second actuator position as a result of the valve spool being moved into the second position. The actuator is mechanically coupled to the coupling element so that the rotor and the drive shaft are coupled to one another via the coupling element in the first actuator position and are decoupled from one another in the second actuator position. As a result, the coupling element can be actuated particularly advantageously via the coupling device by the movement of the valve device between the valve positions or into the valve positions. The actuator is preferably designed as a shifter fork, for example as a linkage.

In a further embodiment, the braking device has at least one cooler which is arranged in the fluid path and through which the fluid can flow and by means of which heat can be dissipated from the fluid, and/or a hydraulic sump which can be or is fluidically connected to the fluid path. This may be understood to mean the following in particular: the fluid path comprises the cooler, through which the fluid flowing through the fluid path can flow, wherein the heat of the fluid flowing through the cooler can be dissipated from the fluid by means of the cooler as a result of the flow, whereby the fluid can be cooled by means of the cooler. This means that the temperature of the fluid can be kept particularly low. Alternatively or additionally, the braking device comprises the hydraulic sump, referred to in particular as an oil sump, which comprises at least one collecting chamber in which the fluid can be collected, wherein the hydraulic sump can be fluidically connected or is connected to the fluid path, whereby the fluid collected in the hydraulic sump can be at least partially discharged from the hydraulic sump and introduced into the fluid path and/or the fluid flowing through the fluid path can be at least partially discharged from the fluid path and introduced into the hydraulic sump. The fluid can be stored particularly advantageously by means of the hydraulic sump, whereby the fluid path can be supplied with the fluid particularly advantageously via the hydraulic sump, for example.

The cooler is preferably designed as a heat exchanger. The heat exchanger can, for example, be designed as a rotary heat exchanger, which can be referred to in particular as a rotatory heat exchanger (RHE). In other words, the heat exchanger preferably has an RHE frame.

It is preferably provided that the fluid can be used or is used as transmission oil for the transmission. In particular, this can be understood to mean that the hydraulic sump is designed as a common hydraulic sump for the braking device and for the transmission, i.e. the braking device and the transmission use a common fluid supply or oil supply.

In a further embodiment, it is provided that the cooler is arranged in a third line section of the fluid path, which is formed separately from the first and second line sections and through which the fluid can flow, wherein the third line section is fluidically connected to the first line section via a connection point, so that the fluid flowing through the first line section can be conveyed to the valve inlet at least partially bypassing the cooler. In other words, the first line section has the connection point by means of which the pump outlet is fluidically connected to the cooler, the pump outlet being fluidically connected to the valve inlet by means of the first line section, bypassing the cooler, the retarder and the hydraulic sump. As a result, the fluid flowing through the third line section can be cooled particularly advantageously by means of the cooler, whereby the temperature of the fluid can be kept particularly low. The fluid flowing through the cooler can be removed from the third line section via the connection point, introduced into the first line section and routed to the pump element via the pump outlet or introduced into the pump element in a second direction of flow of the first line section that is opposite to the first direction of flow of the first line section.

In a further embodiment, the third line section is fluidically connected to a retarder outlet of the retarder, whereby the fluid can be discharged from the retarder via the retarder outlet and supplied to the cooler. In other words, the cooler is arranged in the direction of flow of the fluid discharged from the retarder via the retarder outlet and introduced into the third line section downstream of the retarder outlet and upstream of the connection point, whereby the fluid discharged from the retarder can be cooled by means of the cooler. A branch point is arranged in the third line section, via which the cooler is or can be fluidically connected to the hydraulic sump, bypassing the pump element, the retarder and the valve device. In other words, the third line section has the branch point, by means of which at least part of the fluid contained in the hydraulic sump can be discharged from the hydraulic sump and introduced into the third line section and can be supplied directly to the cooler via the third line section. To put it in other words again, the branch point is arranged in the direction of flow of the fluid flowing from the retarder outlet to the cooler in the third line section between the retarder outlet and the cooler, the connection point being fluidically connectable or connected to the hydraulic sump. The fluid can be removed from the hydraulic sump and introduced into the third line section via the branch point and routed through the cooler, whereby the fluid, in particular the transmission oil, can be cooled in a particularly advantageous manner, whereby the temperature of the fluid, in particular the transmission oil, can be kept particularly low.

The fluid can be cooled both during braking by routing the fluid from the retarder outlet through the cooler via the third line section, and, when the retarder is switched off or the rotor is decoupled, by removing the fluid from the hydraulic sump, introducing it into the third line section via the third branch point and routing it through the cooler.

In a further embodiment, it is provided that the first line section has an extraction point via which the pump element is or can be fluidically connected to a control connection of the valve device, as a result of which the fluid can act on the control connection by means of the pump element, as a result of which the valve device can be moved from the second valve position into the first valve position. In other words, the pump outlet is fluidically connected to the control connection of the valve device via the extraction point directly or bypassing the cooler and bypassing the retarder. To put it in other words again, at least part of the fluid conveyed through the first line section by means of the pump element can be removed from the first line section at the extraction point and supplied to the control connection, as a result of which the fluid can act on the valve device, in particular the valve spool, via the control connection, whereby the valve device can be moved from the second position into the first position or the valve spool can be moved from the second position into the first position as a result of the action. This allows the valve device to be actuated by means of the pump element by adjusting the fluid pressure of the fluid, thereby actuating the coupling element. As a result, the coupling element can be actuated or closed by means of the oil pump, in particular the electric oil pump, which means that no additional control for the coupling element is required in addition to the oil pump. The valve device is therefore preferably a hydraulic switch valve. In other words, a hydraulic changeover of the valve device is coupled with a coupling actuation. The extraction point is preferably arranged downstream of the branch point in the direction of flow of the fluid flowing from the pump element to the valve inlet.

In a further embodiment the fluid path comprises a fourth line section which is formed separately from the line sections and through which the fluid can flow and via which the pump element and the valve device are fluidically connected, bypassing the first line section, the retarder, the valve inlet, the valve outlet and the cooler. In other words, the pump element has a pump inlet through which the fluid can flow and which is spaced apart from the pump outlet, in particular formed separately from the pump outlet, and which is fluidically connected or can be connected to the valve device via the fourth line section, bypassing the pump outlet, the first line section, the retarder, the valve inlet and the valve outlet and the cooler. The fluid flowing through the fourth line section can be supplied to the pump element via the pump inlet and thus introduced into the pump element. The fluid hereby flows through the fourth line section in a first direction of flow of the fourth line section.

It is preferably provided that the valve device has at least one second valve inlet through which the fluid can flow, which is spaced apart from the valve inlet and which is or can be fluidically connected to the fourth line section, and at least one second valve outlet through which the fluid can flow, which is spaced apart from the valve outlet and which is or can be fluidically connected to the hydraulic sump, wherein, in the second valve position, the fluid flowing through the fourth line section in a second direction of flow of the fourth line section opposite to the first direction of flow of the fourth line section can be introduced into the hydraulic sump via the second valve inlet, through the valve device, via the second valve outlet. In other words, the pump element is fluidically connected via the fourth line section, bypassing the first line section, the retarder, the valve inlet, the valve outlet and the cooler, to the second valve inlet, which is formed separately from the valve inlet and the valve outlet, wherein the valve device comprises the second valve outlet formed separately from the valve inlet, the valve outlet and the second valve inlet, which is fluidically connected to the hydraulic sump, bypassing the retarder and the cooler. In the second valve position, the second valve inlet is fluidically connected to the second valve outlet. As a result, for example, the fluid can be removed from the hydraulic sump, in particular by means of the pump element, introduced into the third line section via the branch point, cooled by means of the cooler and introduced into the first line section via the connection point. The fluid flowing through the first line section can then be supplied to the pump element via the pump outlet and discharged from the pump element via the pump inlet and introduced into the fourth line section. The fluid flowing through the fourth line section in the second direction of flow of the fourth line section can then be introduced into the hydraulic sump via the valve device, in particular via the second valve inlet and the second valve outlet. As a result, the fluid cooled by the cooler can be recirculated into the hydraulic sump.

For example, the valve device has a second through-channel which is formed separately from the through-channel, is spaced apart from the through-channel and through which the fluid can flow and which can be connected to the second valve inlet and the second valve outlet. The second through-channel is not, in particular not directly, connected to the through-channel. In the second valve position, the second through-channel is at least partially released, allowing the fluid to flow through the second through-channel and thus be routed from the second valve inlet to the second valve outlet. In the first valve position, the second through-channel is blocked, as a result of which the second valve inlet and the second valve outlet are not fluidically connected to each other, so that the fluid is not routed from the second valve inlet to the second valve outlet.

In a further embodiment, it is provided that the braking device has a second connection point arranged in the fourth line section, via which the fluid flowing through the fourth line section is or can be fluidically connected to the hydraulic sump, bypassing the retarder, the valve device and the cooler. In other words, the fourth line section has the second connection point via which the hydraulic sump is or can be fluidically connected to the pump inlet. As a result, the fluid can be drawn in by means of the pump element and thus removed from the hydraulic sump and supplied to the retarder via the fourth line section, the pump element, in particular the second pump inlet and the pump outlet, via the first line element, the valve device, in particular the valve inlet and the valve outlet, and the second line element via the retarder inlet. As a result, the rotor can be braked using the fluid supplied to the retarder.

In a further embodiment, it is provided that the valve device has at least one second control connection which is spaced apart from the control connection, is fluidically connected to the fourth line section and can be acted upon by the fluid by means of the pump element via the fourth line section, as a result of which the valve device can be moved from the first position into the second position. In other words, the fourth line section has a third connection point formed separately from the second connection point, by means of which the pump inlet of the pump element is or can be connected to the second control connection of the valve device, bypassing the valve device, bypassing the retarder and bypassing the cooler. To put it in other words again, at least part of the fluid flowing through the fourth line section in the second direction of flow of the fourth line section can be removed from the fourth line section via the third connection point and supplied to the second control connection, as a result of which the fluid acts on the latter, whereby the valve device can be moved or is moved from the first position to the second position as a result of the action. As a result, a fluid pressure of the fluid can be provided at the second control connection by means of the pump element, as a result of which the valve device can be moved from the first position to the second position. This means that the coupling element can be actuated by means of the pump element, which means that no additional control provided in addition to the pump element is required to actuate the coupling element. In other words, a hydraulic changeover of the valve device is coupled with a coupling actuation.

An electronic computing device is preferably provided, by means of which the braking device is activated and/or regulated or controlled and/or monitored via the pump element.

In a further embodiment, a check valve through which the fluid can flow is arranged in the second line section between the retarder inlet and the valve outlet. The first check valve is preferably designed to allow the fluid to flow from the valve outlet through the first check valve to the retarder inlet and to prevent the fluid from flowing from the retarder inlet to the valve outlet.

In a further embodiment, a second check valve through which the fluid can flow is arranged in the second line section between the retarder outlet and the cooler, in particular the branch point. The second check valve is preferably designed to allow a flow from the retarder outlet through the second check valve to the cooler, in particular the branch point, and to prevent the fluid from flowing in the opposite direction from the cooler, in particular the branch point, to the retarder outlet.

In a further embodiment, a third check valve through which the fluid can flow is arranged in the third line section between the hydraulic sump and the branch point. The third check valve is preferably designed to allow the fluid to flow from the hydraulic sump through the third check valve to the branch point and to prevent the fluid from flowing in the opposite direction from the branch point to the hydraulic sump.

In a further embodiment, a fourth check valve through which the fluid can flow is arranged in the fourth line section between the pump element, in particular the second connection point, and the valve device, in particular the third connection point. The fourth check valve is preferably designed to allow the fluid to flow from the pump element, in particular the second connection point, through the fourth check valve to the valve device, in particular the third connection point, and to prevent the fluid from flowing in the opposite direction from the valve device, in particular the third connection point, to the pump element, in particular the second connection point.

In a further embodiment, a fifth check valve through which the fluid can flow is arranged in the fourth line section between the hydraulic sump and the second connection point. The fifth check valve is preferably designed to allow the fluid to flow from the hydraulic sump to the second connection point and to prevent the fluid from flowing in the opposite direction from the second connection point to the hydraulic sump.

For example, at least one of the check valves can have a spring element, in particular a contact spring. As a result, for example, the respective flow of the fluid can be permitted from a certain fluid pressure of the fluid, whereby the minimum fluid pressure required for this depends on the spring element, in particular a stiffness of the spring element.

In an operating state of the braking device referred to in particular as synchronization, the valve device is initially in the second valve position. The fluid is conveyed through the first line section by means of the pump element, whereby a pressure build-up of the fluid in the first line section can be achieved. As a result, the fluid or the pressure of the fluid acts on the control connection, whereby the valve device is moved from the second valve position in the direction of the first valve position, in particular because the pressure of the fluid at the control connection is greater than at the second control connection. As a result, the valve spool can be moved from the second position towards the first position and the actuator can be moved from the second actuator position towards the first actuator position. This allows synchronization, in particular locking synchronization, of the rotational speeds of the rotor and the drive shaft by means of the coupling element or a synchronization device. When the valve device has moved to the first valve position as a result of the further action of the fluid or pressure on the control connection, the speeds of the rotor and the drive shaft are synchronized. This can be referred to in particular as a through-connection in the case of synchronization. The valve spool is then in the first position and the actuator is in the first actuator position.

In addition to active control or regulation of the braking device, in particular the retarder, by the pump element, synchronization is also activated by the same pump element. This means that no separate control is required for the synchronizer.

After synchronization, the braking device can switch to an operating mode referred to in particular as standby mode or to an operating mode referred to in particular as braking mode. In braking mode, the pump element is used to build up or modulate the pressure of the fluid in the first line section, whereby the pressure build-up can be greater than the pressure build-up during synchronization, for example. The fact that the valve device is in the first valve position means that the fluid can be introduced into the retarder by means of the pump element via the first line section through the valve device, in particular via the valve inlet and the valve outlet, via the retarder inlet, whereby the pressure of the fluid in the retarder can be increased in particular. As a result, the braking device, in particular the retarder, can build up a braking torque to slow down the drive shaft. This braking torque can be limited, for example, if a temperature threshold value of the fluid temperature is exceeded. For this purpose, a temperature sensor can be provided in the fluid path, preferably in the third line section, to detect the temperature of the fluid. If the temperature detected by the temperature sensor is higher than the temperature threshold value, the braking torque can be limited.

In standby mode, the pressure of the fluid in the first line section is or will be reduced by means of the pump element compared to braking mode. Thus, the pressure of the fluid is reduced relative to the braking mode. It is thereby preferably provided that the fluid does not build up pressure in the fourth line section by means of the pump element, so that the second control connection is preferably not pressurized by the fluid. The synchronization of the speeds of the rotor and the drive shaft remains active. The valve device remains in the first valve position, the valve spool remains in the first position and the actuator remains in the first actuator position.

A further operating mode can be referred to in particular as shutdown. The shutdown can follow standby mode, for example. During shutdown, the fluid is conveyed into the fourth line section by means of the pump element, whereby a pressure build-up of the fluid can be realized in the fourth line section. As a result, the fluid or the pressure of the fluid acts on the second control connection. The pressure of the fluid in the second control connection is greater than in the first control connection, in particular because the pressure build-up takes place in the fourth line section. As a result, the valve device is moved from the first valve position in the direction of the second valve position. The valve device can thereby be moved from the first valve position to the second valve position or the valve device can be moved from the first valve position to an intermediate position, which is located between the first and the second valve position. The pump element in the first line section is preferably in suction mode, i.e. the fluid flowing through the first line section is drawn in by the pump element, conveyed through the pump element and thus introduced into the fourth line section. As a result, the pressure of the fluid in the first line section can be particularly reduced compared to braking operation and particularly increased in the fourth line section, whereby a pressure difference between the pressure of the fluid at the second control connection and the control connection can be particularly increased. The fact that the valve device is moved to the second valve position opens the coupling element, which deactivates the synchronization of the speeds of the rotor and the drive shaft.

A further operating mode can be referred to in particular as cooling mode. The fluid is thereby drawn from the hydraulic sump by means of the pump element, supplied to the cooler arranged in the third line section and then introduced into the hydraulic sump via the fourth line section, the second valve inlet and the second valve outlet. A filter element, referred to in particular as a bypass filter, can thereby be arranged in the direction of flow of the fluid supplied to the cooler upstream of the cooler, in particular in the fourth line section. The fluid can flow through the filter element, allowing the fluid flowing through the filter to be filtered and thus cleaned by means of the filter element.

The pump element is preferably operated in the braking mode in a forward direction, referred to in particular as forward operation, and in the cooling mode in a reverse direction, opposite to the forward direction and referred to in particular as reverse operation.

In a further embodiment, the braking device has a shutdown device. The shutdown device is designed to particularly increase the pressure of the fluid in the fourth line section, in particular very quickly, whereby the pressure of the fluid can be applied to the second control connection, whereby the valve device is moved, in particular very quickly, from the first valve position to the second valve position.

In a further embodiment, the shutdown device is designed as a hydraulic shutdown device. The shutdown device thereby has an inlet through which the fluid can flow and an outlet through which the fluid can flow, which is or can be fluidically connected to the second control connection. The hydraulic shutdown device can be moved between at least two positions, wherein in a first of the positions the inlet and the outlet are fluidically connected, whereby the fluid can flow from the inlet through the shutdown device to the outlet, and in the second position the inlet is not fluidically connected to the outlet, whereby the fluid does not flow through the shutdown device. The shutdown device is provided as a safety shutdown, whereby the safety of the braking device against damage or destruction of the braking device can be particularly increased.

For example, the input can be fluidically connected, in particular directly, to the first retarder outlet or to the second retarder outlet. The hydraulic shutdown device can thereby be moved from the second position to the first position in an operating mode referred to in particular as quick shutdown or safety shutdown, which can follow the braking mode, for example. As a result, the fluid discharged from the retarder via the first retarder outlet or the second retarder outlet can be routed through the shutdown device, in particular via the inlet and the outlet, introduced into the fourth line section and supplied to the second control connection, whereby the pressure in the fourth line section, in particular in the second control connection, can be increased in particular. As a result of the fact in particular that the pressure at the second control connection is then greater than the pressure of the fluid at the first control connection, the valve device can be moved from the first valve position to the second valve position. As a result, the coupling element is opened, which can be referred to in particular as the separation of the rotor and the drive shaft. Optionally, it can be provided that the pressure of the fluid in the first line section and thus at the control connection can in particular be reduced by means of the pump element in suction mode, whereby the pressure difference between the second control connection and the control connection can be increased in particular. The shutdown device can be referred to in particular as a mechanically coupled changeover valve.

Alternatively, the shutdown device can be designed as a pneumatic shutdown device. The pneumatic shutdown device can be moved between at least two positions and has an inlet through which air can flow and an outlet spaced apart from the inlet through which air can flow. The inlet is fluidically connected to a compressed air reservoir, by means of which the pneumatic shutdown device, in particular the inlet, can be supplied with compressed air. The pneumatic shutdown device has a pneumatic cylinder in which a piston element is mounted so that it can move translationally. The piston element can be moved translationally between a first piston position and a second piston position relative to a cylinder wall of the pneumatic cylinder. The cylinder has an orifice through which the air or compressed air can flow and which is or can be fluidically connected to the outlet. The piston element is mechanically connected or coupled to the valve device, in particular the valve spool and/or the coupling device.

In a first of the positions, the inlet is fluidically connected to the outlet, whereby the air from the reservoir can be introduced into the cylinder via the inlet and the outlet, through the orifice, whereby the compressed air acts on the piston element. In the second of the positions, the inlet is not fluidically connected to the outlet, which means that the compressed air does not act on the piston element. Supplying the piston element with compressed air moves the piston element from the first position to the second position. As a result of the piston element and the valve device being mechanically coupled, the valve device is moved from the first valve position to the second valve position when the piston element is moved to the second piston position.

The quick shutdown can be carried out faster than the shutdown, which can be understood in particular to mean that a time period within which the valve device is moved from the first valve position to the second valve position is shorter in the case of quick shutdown than in the case of shutdown. As a result, premature and thus unintentional filling of the retarder with the fluid can be prevented, for example, thereby preventing damage to or destruction of the braking device, in particular the coupling element or the coupling device. As a result, the safety of the braking device can be particularly increased.

Alternatively, in the battery electric vehicle or in the fuel cell vehicle, for example, the shutdown device and thus the safety shutdown can be dispensed with if the electric machine for driving the motor vehicle can compensate for the braking torque particularly quickly and thus quickly enough in the case of an active anti-lock braking system (ABS).

The shutdown device is preferably activated electrohydraulically or electropneumatically. In particular, this can be understood to mean that in the case of the shutdown device designed as a hydraulic shutdown device and in the case of the shutdown device designed as a pneumatic shutdown device, the respective shutdown device can be moved from the first position to the second position by means of an electric motor.

The shutdown device preferably has at least one spring element by means of which the shutdown device can be moved from the second position to the first position.

Further advantages, features and details of the invention are apparent from the following description of preferred embodiments and from the drawings. The features and combinations of features mentioned above in the description as well as the features and combinations of features mentioned below in the description of the figures and/or shown alone in the figures can be used not only in the combination indicated in each case, but also in other combinations or on their own, without departing from the scope of the invention.

In the drawings:

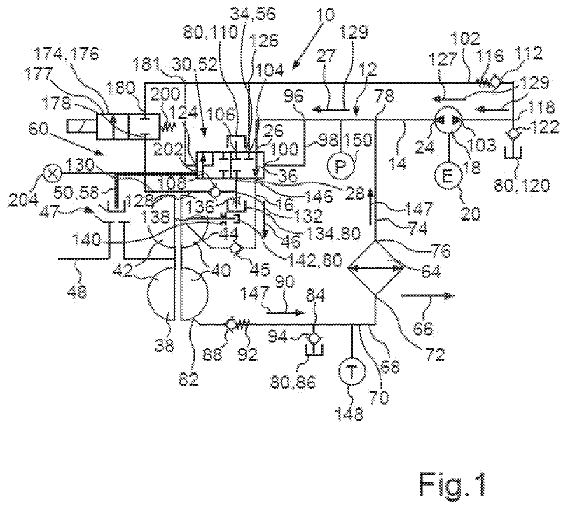

FIG. 1 shows a schematic sectional view of a braking device according to the invention in a first valve position; and

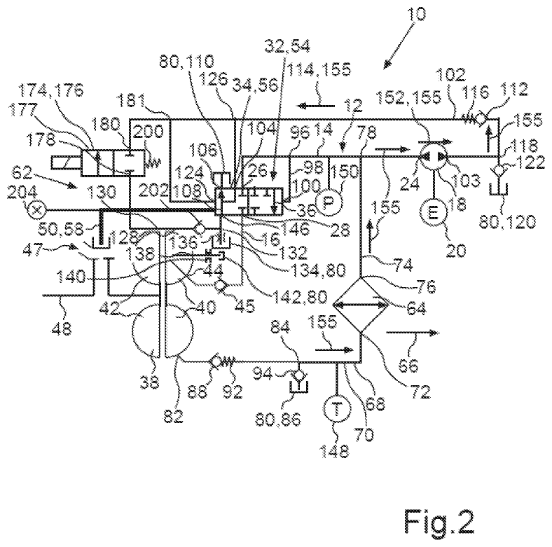

FIG. 2 shows a schematic sectional view of a braking device according to the invention in a second valve position; and

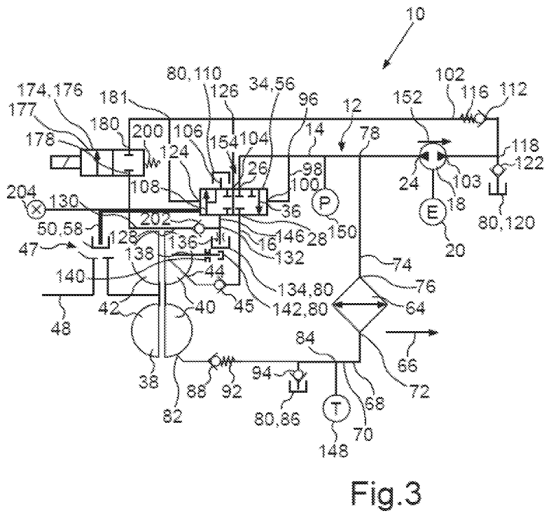

FIG. 3 shows a schematic sectional view of a braking device according to the invention in an intermediate position; and

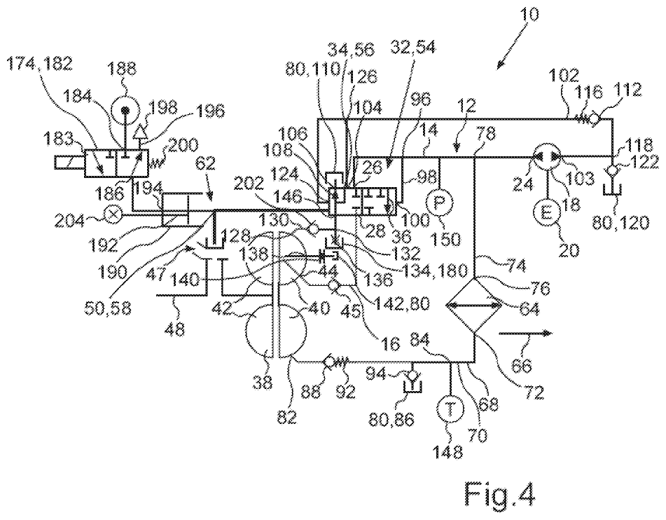

FIG. 4 shows a schematic sectional view of a braking device according to the invention in accordance with a further embodiment.

Identical or functionally identical elements are marked with the same reference signs in the figures.

FIG. 1 shows a schematic sectional view of a braking device 10 for a motor vehicle. The motor vehicle is preferably designed as a commercial vehicle. For example, the motor vehicle is designed as a motor vehicle, in particular as a passenger car, commercial vehicle or truck, or as a passenger bus.

The braking device 10 comprises a fluid path 12 through which a fluid can flow, which can be referred to in particular as a hydraulic system. The fluid path 12 has at least two line sections 14, 16 through which the fluid can flow. At least one pump element 18 is arranged in the fluid path 12 for conveying the fluid through the fluid path 12. The pump element 18 is preferably designed as an electric pump. The pump element 18, which is designed as an electric pump, can be driven by an electric motor 20. The pump element 18 is fluidically connected to a first of the line sections 14 via a pump outlet 24 of the pump element 18. At least one valve device 34 is arranged in the fluid path 12, through which the fluid can flow, which has at least one valve inlet 26 and one valve outlet 28 and which can be moved between at least two valve positions 30, 32. The valve device 34 is fluidically connected to the first line section 14 via the valve inlet 26, whereby the valve inlet 26 is fluidically connected to the pump element 18, in particular the pump outlet 24. The valve device 34 has a through-channel 36 through which the fluid can flow and which can be fluidically connected to the valve inlet 26 and the valve outlet 28.

The braking device 10 has a retarder 38, which comprises a stator 40 and a rotor 42, which is formed separately from the stator 40 and can rotate about an axis of rotation relative to a housing element of the retarder 38. The retarder 38 has a retarder inlet 44, via which the retarder 38 is fluidically connected to the valve device 34 by means of the second line section 16 via the valve outlet 28.

In a first of the valve positions 30, the valve inlet 26 is fluidically connected to the valve outlet 28 via the through-channel 36, whereby the fluid flowing through the first line section 14 can be supplied to the retarder inlet 44 via the valve inlet 26 through the valve device 34, via the valve outlet 28 and via the second line section 16. As a result, the fluid can be introduced into the retarder 38. In FIG. 1, the valve device 34 is in the first valve position 30.

FIG. 2 shows a schematic sectional view of the braking device 10, with the valve device 34 in the second valve position 32. In the second valve position 32, the valve inlet 26 is not fluidically connected to the valve outlet 28, as a result of which the fluid flowing through the first line section 14 cannot enter the through-channel 28 via the valve inlet 26 and thus cannot be introduced into the second line section 16 via the valve outlet 28. As a result, the fluid is not supplied from the first line section 14 via the valve device 34 to the retarder 38, in particular the retarder inlet 44, in the second valve position 32.

A first check valve 45, through which the fluid can flow, is arranged between the valve outlet 28 and the retarder inlet 44 in the second line section 16. The check valve 45 is designed to allow the fluid to flow in a direction of flow 46 from the valve outlet 28 through the check valve 45 to the retarder inlet 44 and to prevent the fluid from flowing in the opposite direction of flow 46 from the retarder inlet 44 to the valve outlet 28.

In order to be able to keep the installation space and costs of the braking device 10 particularly low, the braking device 10 has at least one coupling element 47, via which the rotor 42 can be coupled to a drive shaft 48 of the motor vehicle and decoupled from the drive shaft 48. In addition, the braking device 10 has a coupling device 50, by means of which the rotor 42 and the drive shaft 48 can be coupled via the coupling element 47 by moving the valve device 34 into the first valve position 30 and can be decoupled by moving the valve device 34 into the second valve position 32. When the valve device 34 is in the first valve position 30, the coupling element 47 is closed, whereby the drive shaft 48 and the rotor 42 are mechanically coupled. When the valve device 34 is in the second valve position 32, the coupling element 47 is open, whereby the drive shaft 48 and the rotor 42 are decoupled.

In a further embodiment, the valve device 34 has a valve spool 56 that can be moved between at least two positions 52, 54. The valve spool 56 is arranged in the first valve position 30 in a first of the positions 52 and in the second valve position 32 in the second of the positions 54. The coupling device 50 is designed as an actuator 58 mechanically coupled to the valve spool 56, which can be moved between at least two actuator positions 60, 62. The actuator 58 can be moved to a first one of the actuator positions 60 by moving the valve spool 56 to the first position 52, whereby the rotor 42 and the drive shaft 48 are coupled via the coupling element 47. By moving the valve spool 56 to the second position 54, the actuator 58 can be moved to the second of the actuator positions 62, whereby the rotor 42 and the drive shaft 48 are decoupled.

In a further embodiment, a cooler 64 through which the fluid can flow and by means of which heat 66 can be dissipated from the fluid is arranged in a third line section 68 through which the fluid can flow and which is formed separately from the first and second line sections 14, 16. A first segment 70 of the third line section 68 is fluidically connected to a cooler inlet 72 of the cooler 64. A second segment 74 of the third line section 68 is fluidically connected to a cooler outlet 76 of the cooler 64. The third line section 68, in particular the second segment 74, is fluidically connected to the first line section 14 via a connection point 78, so that the fluid flowing through the first line section 14 can be conveyed to the valve inlet 26 bypassing at least in part the cooler 64.

In a further embodiment, the braking device 10 has a hydraulic sump 80 that is or can be fluidically connected to the fluid path 12 and in which the fluid can be collected or stored. The fluid is preferably oil, which is provided as transmission oil of a transmission of the motor vehicle, whereby the hydraulic sump 80 is a common sump for the transmission and the braking device 10, in particular the retarder 38 or the fluid path 12.

The third line section 68 is fluidically connected to a retarder outlet 82 of the retarder 38, whereby the fluid can be discharged from the retarder 38 via the retarder outlet 82, can be introduced into the third line section 68, in particular the first segment 70, and can be supplied to the cooler 64, whereby the fluid can be cooled. A branch point 84 is arranged in the third line section 68, in particular in the first segment 70, via which the third line section 68, in particular the first segment 70, is fluidically connected to the hydraulic sump 80 via a first sump access 86.

In the third line section 68, in particular in the first segment 70, a second check valve 88 through which the fluid can flow is arranged between the retarder outlet 82 and the cooler 64, in particular downstream of the branch point 84. The second check valve 88 is preferably designed to allow the fluid to flow in a direction of flow 90 from the retarder outlet 82 to the cooler 64, in particular to the branch point 84, and to prevent the fluid from flowing in the opposite direction of flow 90 from the branch point 84 or from the cooler 64 or from the first sump access 86. The second check valve 88 has a spring element 92, whereby the second check valve 88 is designed as a spring-loaded check valve. A third check valve 94, through which the fluid can flow, is arranged between the first sump access 86 and the branch point 84. The third check valve 94 is designed to allow fluid to flow from the hydraulic sump 80 via the first sump access 86 through the third check valve 94 to the branch point 84 and to prevent the fluid from flowing in the opposite direction from the branch point 84 to the first sump access 86.

In a further embodiment, the first line section 14 has an extraction point 96 arranged in the direction of flow 27 of the fluid flowing from the pump element 18 to the valve inlet 26 downstream from the connection point 78. The first line section 14 is fluidically connected via the extraction point 96 to a first line element 98 through which the fluid can flow. The first line element 98 is fluidically connected at one end to the extraction point 96 and at the other end to a control connection 100 of the valve device 34. As a result, the pump element 18, in particular the pump outlet 24, is fluidically connected to the control connection 100 of the valve device 34 via the extraction point 96, as a result of which the fluid can act on the control connection 100 by means of the pump element 18, whereby the valve device 34 can be moved from the second valve position 32 to the first valve position 30. As a result, the closed coupling element 47 can be opened.

In a further embodiment, the fluid path 12 has a fourth line section 102 which is formed separately from the line sections 14, 16, 68 and through which the fluid can flow and via which the pump element 18 and the valve device 34 are fluidically connected, bypassing the first line section 14, the retarder 38, the valve inlet 26, the valve outlet 28 and the cooler 64. The pump element 18 is fluidically connected to the valve device 34 via a pump inlet 103 spaced apart from the pump outlet 24 via the fourth line section 102.

In a further embodiment, the valve device 34 has a second valve inlet 104 spaced apart from the valve inlet 26 and fluidically connected to the fourth line section 102 and at least one second valve outlet 106 spaced apart from the valve outlet 28. The pump element 18 is fluidically connected to the second valve inlet 104 via the fourth line section 102, bypassing the first line section 14, the retarder 38, the valve inlet 26, the valve outlet 28 and the cooler 64. The valve device 34 has a second through-channel 108 which is spaced apart from the through-channel 36 and through which the fluid can flow and which can be fluidically connected to the second valve inlet 104 and the second valve outlet 106. The second valve outlet 106 is fluidically connected to the hydraulic sump 80 via a second sump access 110. In the second valve position 32, the second valve inlet 104 and the second valve outlet 106 are fluidically connected, whereby the fluid flowing through the fourth line section 102 can be introduced into the second through-channel 108 via the second valve inlet 104 and can thus be introduced into the hydraulic sump 80 through the valve device 34, via the second valve outlet 106, via the second sump access 110. In the first valve position 30, the second valve inlet 104 is not fluidically connected to the second valve outlet 106, as a result of which the fluid flowing through the fourth line section 102 is not introduced into the hydraulic sump 80 via the valve device 34, in particular the second through-channel 108, via the second sump access 110.

A fourth check valve 112, through which the fluid can flow, is arranged between the pump element 18 and the second valve inlet 104 in the fourth line section 102. The fourth check valve 112 is designed to allow the fluid to flow in a direction of flow 114 from the pump element 18, in particular the pump inlet 103, to the second valve inlet 104 and to prevent the fluid from flowing from the second valve inlet 104 to the pump element 18, in particular the pump inlet 103, in the opposite direction to the direction of flow 114. The fourth check valve 112 has a spring element 116, whereby the fourth check valve 112 is designed as a spring-loaded check valve.

In a further embodiment, a second connection point 118 arranged in the fourth line section 102 is provided, via which the fluid flowing through the fourth line section 102 is fluidically connected to the hydraulic sump 80 via a third sump access 120, bypassing the retarder 38 and the valve device 34 and the cooler 64. A fifth check valve 122, through which the fluid can flow, is arranged between the third sump access 120 and the second connection point 118. The fifth check valve 122 is designed to allow fluid to flow through the fifth check valve 122 from the third sump access 120 to the second connection point 118, and to prevent fluid from flowing in the opposite direction from the second connection point 118 to the third sump access 120.

In a further embodiment, the valve device 34 has a second control connection 124 spaced apart from the control connection 100. The second control connection 124 is fluidically connected to the fourth line section 102 via a third connection point 126, whereby the fluid can act on the second control connection 124 by means of the pump element 18 via the pump inlet 103 and the fourth line section 102. This means that the fluid flowing through the first line section 14 can, for example, be drawn in by the pump element 18 in the opposite direction of flow 27, be introduced into the fourth line section 102 via the pump outlet 24 through the pump element 18 and via the pump inlet 103, whereby the fluid flowing through the fourth line section 102 is supplied to the second control connection 124 by means of the pump element 18 via the third connection point 126. By pressurizing the second control connection 124 with the fluid or a pressure of the fluid, the valve device 34 can be moved from the first valve position 30 to the second valve position 32. As a result, the closed coupling element 47 can be opened.

In an operating mode of the braking device 10 referred to in particular as synchronization, the valve device 34 is initially in the second valve position 32. The fluid from the third sump access 120 is drawn or extracted from the hydraulic sump 80 by means of the pump element 18 and introduced into the first line section 14 via the second connection point 118 through the pump inlet 103 and the pump outlet 24. The fluid flowing through the first line section 14 is conveyed by means of the pump element 18 via the extraction point 96 to the control connection 100, whereby the fluid or a pressure of the fluid acts on the control connection 100. This is illustrated by arrows 129. As a result, the pressure of the fluid at the control connection 100 is particularly increased by means of the pump element 18, whereby the pressure of the fluid at the control connection 100 is greater than the pressure of the fluid at the second control connection 124. There is therefore a positive pressure difference between the control connections 100, 124. As a result of the positive pressure difference, the valve device 34 is moved from the second valve position 32 in the direction of the first valve position 30. As a result of this, the valve spool 56 is moved from the second position 54 towards the first position 52, whereby the actuator 58 mechanically coupled to the valve spool 56 is moved from the second actuator position 62 towards the first actuator position 60. As a result, the coupling element 47 is used to synchronize the respective speeds of the drive shaft 48 and the rotor 42, in particular by means of locking synchronization. When the valve device 34 has been moved from the second position 32 to the first valve position 30, the speeds of the drive shaft 48 and the rotor 42 are synchronized. In particular, this can be understood to mean that the respective speeds of the rotor 42 and the drive shaft 48 are identical.

In a further embodiment, the retarder 38 has a second retarder outlet 128 spaced apart from the retarder outlet 82, which is fluidically connected to a second line element 130 through which the fluid can flow. The third line element 130 is fluidically connected to the hydraulic sump 80 via a fourth connection point 132 via a fourth sump access 134. A first restriction 136 is arranged between the fourth connection point 132 and the fourth sump access 134. The fluid can be discharged from the retarder 38 via the second retarder outlet 128, introduced into the second line element 130 and introduced into the hydraulic sump 80 via the fourth sump access 134 via the fourth connection point 132 and the first restriction 136. As a result, pressure can be reduced in the retarder 38 or the retarder 38 can be vented.

In the embodiment shown in FIG. 1 and FIG. 2, the retarder 38 has a third retarder outlet 138 through which the fluid can flow and which is spaced apart from the retarder outlet 82 and the second retarder outlet 128. The third retarder outlet 138 is fluidically connected to the hydraulic sump 80 via a second restriction 140 and a fifth sump access 142. As a result, the fluid discharged from the retarder 38 via the third retarder outlet 138 can be introduced into the hydraulic sump 80 via the second restriction 140 and the fifth sump access 142.

In a further embodiment, the valve device 34 has a third valve inlet 146 spaced apart from the valve inlet 26, the valve outlet 28, the second valve inlet 104 and the second valve outlet 106. In the second valve position 32, the third valve inlet 146 is fluidically connected to the second valve outlet 106, in particular via the second through-channel 108, whereby the fluid discharged from the retarder 38 via the second retarder outlet 128 can be introduced into the hydraulic sump 80 via the second line element 130, in particular the fourth connection point 132, the third valve inlet 146, the second valve outlet 106 via the second sump access 110. In the first valve position 30, the third valve inlet 146 is not fluidically connected to the second valve outlet 106, as a result of which the fluid from the second line element 130 is not introduced into the hydraulic sump 80 via the third valve inlet 146 and the second valve outlet 106 via the second sump access 110.

Preferably, the synchronization provides that before the valve device 34 is moved in the direction of the first valve position 30, while the valve device 34 is in the second valve position 32, the fluid is discharged from the retarder 38 via the second retarder outlet 128 to reduce the pressure in the retarder 38, is introduced into the second line element 130 and is introduced into the hydraulic sump 80 via the fourth connection point 132, third valve inlet 146, the second valve outlet 106 and the second sump access 110.

The synchronization can, for example, be followed by an operating mode of the braking device 10, in particular referred to as braking mode. In the braking mode, the fluid is drawn from the fourth line section 102 by means of the pump element 18, whereby the fluid is removed from the hydraulic sump via the third sump access 120, is introduced into the fourth line section 102 and flows through the pump element 18 via the second connection point 118 in the first direction of flow 127. The fluid flows into the first line section 14 via the pump inlet 103 and the pump outlet 24. This is illustrated by the arrows 129. As a result, a pressure of the fluid is built up in the first line section 14 by means of the pump element 18, which is preferably greater than during synchronization. Due to the fact that the valve device 34 is in the first valve position 30, the fluid flowing through the first line section 14 can be introduced via the valve inlet 26 through the through-channel 36 via the valve outlet 28 into the second line section 16 and can thus be supplied to the retarder 38 via the retarder inlet 44. The fluid is therefore introduced into the retarder 38. As a result, the pressure of the fluid in the retarder 38 can be particularly increased, especially compared to synchronization. In particular as a result of the particularly high pressure of the fluid in the retarder 38, the rotor 42 is decelerated by the fluid, whereby the drive shaft 48 is decelerated as a result of the mechanical coupling of the rotor 42 with the drive shaft 48 via the closed coupling element 47. As a result, the vehicle can be braked.

In the braking mode, the fluid is discharged from the retarder 38 via the retarder outlet 82 and introduced into the third line section 68, passed through the cooler 64 and reintroduced into the first line section 14 via the connection point 78. This is illustrated by arrows 147. As a result, the fluid can be cooled in the braking mode.

In the third line section 68, in particular in the first segment 70, a temperature sensor 148 is arranged between the branch point 84 and the cooler 64. The temperature sensor 148 is designed to detect a temperature of the fluid flowing through the third line section 68. For example, it may be provided that, if the temperature of the fluid detected by the temperature sensor 148 exceeds a predetermined temperature threshold value in the braking mode, a braking torque applied to the drive shaft 48 by the braking device 10, in particular the retarder 38, is limited. This can be achieved, for example, by using the pump element 18 to particularly reduce a mass flow of the fluid conveyed from the fourth line section 102 into the first line section 14. A pressure sensor 150 is arranged in the first line section 14, in particular between the connection point 78 and the extraction point 96, by means of which a pressure of the fluid flowing through the first line section 14 can be detected.

An operating mode of the braking device 10, known in particular as standby mode, can in particular follow the braking mode or synchronization. The pressure of the fluid in the first line section 14 is thereby particularly reduced by means of the pump element 18, in particular compared to the braking mode. For example, the mass flow of the fluid is particularly reduced, whereby the pump element 18 can be decelerated to a standstill. It is thereby provided that in the fourth line section 102, in particular in the second control connection 124, there is no pressure build-up, in particular with respect to the braking mode. As a result, the synchronization remains active, i.e. the speeds of the drive shaft 48 and the rotor 42 are synchronous with each other, whereby the drive shaft 48 is not braked by the rotor 42.

An operating mode of the braking device 10, which is referred to in particular as shutdown, can, for example, follow the standby mode or the braking mode. The fluid is thereby drawn from the hydraulic sump 80 via the first sump access 86 by means of the pump element 18 and thus introduced into the third line section 68 via the connection point 84. As a result of the suction, the fluid flowing through the third line section 68 is routed through the cooler 64 and introduced into the pump element 18 via the pump outlet 24 and discharged from the pump element 18 via the pump inlet 103 and introduced into the fourth line section 102. Thus, the fluid flows through the pump element 18 in a second direction of flow 152, which is opposite to the first direction of flow 127. The fluid flowing through the fourth line section 102 is supplied to the second control connection 124 via the fourth check valve 112 and via the third connection point 126 by means of the pump element 18. As a result, the fluid or the pressure of the fluid acts on the second control connection 124. As a result of the pressurization, the pressure of the fluid at the second control connection 124 is greater than at the control connection 100. This means that there is a negative pressure difference between the control connections 100, 124. As a result of the pressurization or the negative pressure difference, the valve device 34 is moved from the first valve position 30 in the direction of the second valve position 32. As a result of this, the closed coupling element 47 is opened, whereby the drive shaft 48 and the rotor 42 are decoupled so that the drive shaft 48 is not decelerated by the rotor 42. Opening the coupling element 47 deactivates the synchronization, i.e. the speeds of the drive shaft 48 and the rotor 42 can be different from each other.

In the shutdown mode, the valve device 34 is preferably in an intermediate position 154, which differs from the first and second valve positions 30, 32, or the valve device 34 is moved to the intermediate position 154 in the shutdown mode. FIG. 3 shows a schematic sectional view of the braking device 10, with the valve device 34 in the intermediate position 154. The valve device 34 is in the intermediate position 154 between the first and second valve positions 30, 32, by which it can be understood in particular that the valve spool 56 is arranged between the first and second positions 52, 54. In the intermediate position 154, the respective valve inlets 26, 106, 146 are not fluidically connected to the respective valve outlets 28, 106, as a result of which the fluid cannot flow through the valve device 34, in particular the first and second through-channels 36, 108. Alternatively, in the shutdown mode, the valve device 34 can be moved to the second valve position 32 as a result of the pressurization or the negative pressure difference of the first valve position 30.

An operating mode referred to in particular as cooling mode can, for example, follow shutdown. The pressure in the fourth line section 102, in particular at the second control connection 124, is thereby particularly increased by means of the pump element 18, whereby the valve device 34 is moved into the second valve position 32. The fluid is drawn from the hydraulic sump 80 via the first sump access 86 by means of the pump element 18 and thereby introduced into the third line section 68. As a result of the suction, the fluid is routed through the cooler 64, whereby the fluid can be cooled. The fluid then flows through the pump element 18 in the second direction of flow 152 via the connection point 78 and the first line section 14. As a result, the fluid is introduced into the fourth line section 102 and supplied to the second valve inlet 104 by means of the pump element 14 via the third connection point 126. This is illustrated by arrows 155. As a result of the valve device 34 being in the second valve position 32, the fluid can then be introduced into the hydraulic sump 80 via the second valve inlet 104 through the second through-channel 108 and via the second valve outlet 106 via the second sump access 110. Thus, for example, the fluid can be removed from the transmission and supplied to the fluid path 12 from the hydraulic sump 80 via the first sump access 86, cooled by means of the cooler 64 and then returned to the transmission via the second sump access 110 and the hydraulic sump 80.

In a further embodiment, the braking device has a shutdown device 174. The shutdown device 174 is designed to particularly increase the pressure of the fluid in the fourth line section 102, in particular very quickly, whereby the pressure of the fluid can be applied to the second control connection 124, whereby the valve device 34 is moved, in particular very quickly, from the first valve position 30 to the second valve position 32.

In the embodiment shown in FIGS. 1-3, the shutdown device 174 is designed as a hydraulic shutdown device 176. The hydraulic shutdown device 176 has an electric switch valve 177 with an inlet 178 through which the fluid can flow and an outlet 180 through which the fluid can flow, which is or can be fluidically connected to the second control connection 124. The electric switch valve 177 can be moved between at least two positions, wherein in a first of the positions the inlet 178 and the outlet 180 are fluidly connected, whereby the fluid can flow from the inlet 178 through the electric switch valve 177 to the outlet 180, and in the second position the inlet 178 is not fluidly connected to the outlet 180, whereby the fluid does not flow through the electric switch valve. In FIGS. 1-3, the switch valve 177 of the hydraulic shutdown device 176 is shown in the second position.

The inlet 178 is fluidically connected to the third retarder outlet 138 via the third line element 130. In an operating mode referred to in particular as a quick shutdown mode, which may, for example, follow the braking mode, the electric switch valve 177 of the hydraulic shutdown device 176 can thereby be moved from the second position to the first position. As a result, the fluid discharged from the retarder 38 via the third retarder outlet 138 can be routed through the electric switch valve 177, in particular via the inlet 178 and the outlet 180, introduced into the fourth line section 102 and supplied to the second control connection 124, whereby the pressure in the fourth line section 102, in particular in the second control connection 124, can be particularly increased. For this purpose, the output 180 is fluidically connected to the fourth line section 102 via a fifth connection point 181. As a result, in particular, of the pressure at the second control connection 124 then being greater than the pressure of the fluid at the first control connection 100, the valve device 34 can be moved from the first valve position 30 to the second valve position 32. As a result, the coupling element 47 is opened.

Alternatively, the shutdown device 176 can be designed as a pneumatic shutdown device 182. FIG. 4 shows a schematic sectional view of the braking device 10, with the valve device 34 in the second valve position 32 and the shutdown device 176 is designed as a pneumatic shutdown device 182. The pneumatic shutdown device 182 has an electric switch valve 183 that can be moved between at least two positions and comprises an inlet 184 through which air can flow and an outlet 186 spaced apart from the inlet through which air can flow. The inlet 184 is fluidically connected to a compressed air reservoir 188, by means of which the pneumatic shutdown device 182, in particular the inlet 184, can be supplied with compressed air. The pneumatic shutdown device 182 has a pneumatic cylinder 190 in which a piston element 192 is mounted so that it can move translationally. The piston element 192 can be moved translationally between a first piston position and a second piston position relative to a cylinder wall of the pneumatic cylinder 190. The cylinder 190 has an orifice 194 through which the air or compressed air can flow, which is fluidically connected to the outlet 186. The piston element 192 is mechanically connected or coupled to the valve device 34, in particular the valve spool 56 and/or the coupling device 50. In FIG. 4, the electric switch valve 183 of the pneumatic shutdown device 182 is shown in the second position.

In a first of the positions of the electric switch valve 183, the inlet 184 is fluidically connected to the outlet 186, whereby the air from the compressed air reservoir 188 can be introduced into the cylinder 190 via the inlet 184, through the electric switch valve 183, the outlet 186, through the orifice 194, whereby the compressed air acts on the piston element 192. In the second of the positions, the inlet 184 is not fluidically connected to the outlet 186, as a result of which the compressed air cannot flow through the electric switch valve 183 and the compressed air does not act on the piston element 192. Supplying the piston element 192 with compressed air moves the piston element 192 from the first piston position to the second piston position. As a result of the piston element 192 and the valve device 34 being mechanically coupled, the valve device is moved from the first valve position 30 to the second valve position 32 when the piston element 192 is moved to the second piston position. In FIG. 4, the piston element 192 is in the second piston position.

The pneumatic shutdown device 182 has a second outlet 196 through which the air can flow and which is spaced apart from the inlet 184 and the outlet 186 and which is fluidically connected to a venting device 198. In the second position of the electric switch valve 183, the outlet 186 is fluidically connected to the second outlet 196, whereby the air can be discharged from the cylinder 190 and supplied to the venting device 198 via the outlet 186 and the second outlet 196. As a result, the cylinder 190 can be vented by means of the venting device 198.

The shutdown device 174, in particular the hydraulic and pneumatic shutdown devices 176, 182, has at least one spring element 200, by means of which the shutdown device 174 can be moved from the second position to the first position.

In the exemplary embodiment shown in FIGS. 1-3, a sixth check valve 202 through which the fluid can flow is arranged in the third line element 130 between the third retarder outlet 138 and the fourth connection point 132. The sixth check valve 202 is designed to allow fluid to flow from the third retarder outlet 128 and/or from the inlet 178 through the sixth check valve 202 to the fourth connection point 132, and to prevent fluid from flowing in the opposite direction from the fourth connection point 132 to the third retarder outlet 128 and/or to the inlet 178.

The braking device has a position sensor 204, which is designed to detect the respective valve position 30, 32 and/or the respective position 52, 54 and/or the respective actuator position 60, 62.

### LIST OF REFERENCE SIGNS

10 Braking device
12 Fluid path
14 First line section
16 Second line section
18 Pump element
20 Electric motor
24 Pump outlet
26 Valve inlet
27 Direction of flow
28 Valve outlet
30 First valve position
32 Second valve position
34 Valve device
36 Through-channel
38 Retarder
40 Stator
42 Rotor
44 Retarder inlet
45 First check valve
46 Direction of flow
47 Coupling element
48 Drive shaft
50 Coupling device
52 First position
54 Second position
56 Valve spool
58 Actuator
60 First actuator position
62 Second actuator position
64 Cooler
66 Heat
68 Third line section
70 First segment
72 Cooler inlet
76 Second segment
77 Cooler outlet
78 Connection point
80 Hydraulic sump
82 Retarder outlet
84 Branch point
86 First sump access
88 Second check valve
90 Direction of flow
92 Spring element
94 Third check valve
96 Extraction point
98 First line element
100 Control connection
102 Fourth line section
103 Pump inlet
104 Second valve inlet
106 Second valve outlet
108 Second through-channel
110 Second sump access
112 Fourth check valve
114 Direction of flow
116 Spring element
118 Second connection point
120 Third sump access
122 Fifth check valve
124 Second control connection
126 Third connection point
127 First direction of flow
128 Second retarder outlet
129 Arrows
30 Second line element
132 Fourth connection point
134 Fourth sump access
136 First restriction
138 Third retarder outlet
140 Second restriction
142 Fifth sump access
146 Third valve inlet
147 Arrows
148 Temperature sensor
150 Pressure sensor
152 Second direction of flow
154 Intermediate position
155 Arrows
174 Shutdown device
176 Hydraulic shutdown device
177 Switch valve
178 Outlet
180 Inlet
181 Fifth connection point
182 Pneumatic switch-off device
183 Switch valve
184 Inlet
186 Outlet
188 Compressed air reservoir
190 Cylinder
192 Piston element
194 Orifice
196 Second outlet
198 Venting device
200 Spring element
202 Sixth check valve
204 Position sensor

1. Braking device (10) for a motor vehicle, having a fluid path (12) through which a fluid can flow and which has at least two line sections (14, 16), in which at least one pump element (18) for conveying the fluid through the fluid path (12) and at least one valve device (34) is arranged, through which the fluid can flow and which has at least one valve inlet (26) and one valve outlet (28) and which can be moved between at least two valve positions (30, 32), which is fluidically connected to the pump element (18) via the valve inlet (26) by means of a first line section (14) of the line sections (14, 16), with a retarder (38), which has a stator (40) a rotor (42) formed separately from the stator (40) and a retarder inlet (44), via which the retarder (38) is fluidically connected to the valve device (34) via the valve outlet (28) by means of a second line section (16) of the line sections (14, 16), wherein the valve inlet (26) is fluidically connected to the valve outlet (28) in a first of the valve positions (30), whereby the fluid flowing through the first line section (14) can be supplied through the valve device (34) via the second line element (16) to the retarder inlet (44), and in the second valve position (32) the valve inlet (26) is not fluidically connected to the valve outlet (28),
characterized in that
at least one coupling element (47), via which the rotor (42) can be coupled to a drive shaft (48) of the motor vehicle and can be decoupled from the drive shaft (48), and a coupling device (50), by means of which the rotor (42) and the drive shaft (48) can be coupled via the coupling element (47) by moving the valve device (34) into the first valve position (30) and can be decoupled by moving the valve device (34) into the second valve position (32).

2. Braking device (10) according to claim 1
characterized in that
the valve device (34) has a valve spool (56) which can be moved between at least two positions (52, 54), which is arranged in a first of the positions (52) in the first valve position (30) and is arranged in the second of the positions (54) in the second valve position, and the coupling device (50) is designed as an actuator (58) which is mechanically coupled to the valve spool (56) and can be moved between at least two actuator positions (60, 62), wherein the actuator (58) can be moved into a first of the actuator positions (60) by moving the valve spool (56) into the first position (52), whereby the rotor (42) and the drive shaft (48) are coupled via the coupling element (47), and can be moved into a second of the actuator positions (62) by moving the valve spool (56) into the second position (54), whereby the rotor (42) and the drive shaft (48) are decoupled.

3. Braking device (10) according to claim--of-
characterized in that
it has at least one cooler (64) which is arranged in the fluid path (12) and through which the fluid can flow and by means of which heat (66) can be dissipated from the fluid, and/or a hydraulic sump (80) which can be fluidically connected to the fluid path (12).

4. Braking device (10) according to claim 3,
characterized in that
the cooler (64) is arranged in a third line section (68) of the fluid path (12), which is formed separately from the first and second line sections (14, 16), wherein the third line section (68) is fluidically connected to the first line section (14) via a connection point (78), so that the fluid flowing through the first line section (14) can be conveyed to the valve inlet (26) bypassing the cooler (64).

5. Braking device (10) according to claim 4,
characterized in that
the third line section (68) is fluidically connected to a retarder outlet (82) of the retarder (38), whereby the fluid can be discharged from the retarder (38) via the retarder outlet (82) and supplied to the cooler (64), wherein a branch point (84) is arranged in the third line section (68), via which the cooler (64) is fluidically connected to the hydraulic sump (80), bypassing the pump element (18), the retarder (38) and the valve device (34).

6. Braking device (10) according to claim 4,
characterized in that
the first line section (14) has an extraction point (96) via which the pump element (18) is fluidically connected to a control connection (100) of the valve device (34), as a result of which the fluid can act on the control connection (100) by means of the pump element (18), as a result of which the valve device (34) can be moved from the second valve position (32) into the first valve position (30).

7. Braking device (10) according to claim 4,
characterized in that
the fluid path (12) comprises a fourth line section (102) which is formed separately from the line sections (14, 16, 68) and through which the fluid can flow and via which the pump element (18) and the valve device (134) are fluidically connected, bypassing the first line section (14), the retarder (38), the valve inlet (26) and the valve outlet (28).

8. Braking device (10) according to claim 7,
characterized in that
the valve device (34) has at least one second valve inlet (104) spaced apart from the valve inlet (26) and fluidically connected to the fourth line section (102) and at least one second valve outlet (106) spaced apart from the valve outlet (28) and fluidically connected to the hydraulic sump (80), wherein in the second valve position (32), the fluid flowing through the fourth line section (102) can be introduced into the hydraulic sump (80) via the second valve inlet (104), through the valve device (34) via the second valve outlet (106).

9. Braking device (10) according to claim 7,
characterized in that
a second connection point (118) is arranged in the fourth line section (102), via which the fluid flowing through the fourth line section (102) is fluidically connected to the hydraulic sump (80), bypassing the retarder (38) and the valve device (34).

10. Braking device (10) according to claim 7,
characterized in that
the valve device (34) has at least one second control connection (124) which is spaced apart from the control connection (100), is fluidically connected to the fourth line section (102) and can be acted upon by the fluid by means of the pump element (18) via the fourth line section (102), as a result of which the valve device (34) can be moved from the first position (30) into the second position (32).
